(19) United States
(12) Patent Application Publication
(10) Pub. No.: US 2008/0024823 A1
(43) Pub. Date: Jan. 31, 2008

(54) Image processing apparatus and image reading apparatus

(75) Inventor: Jun Nakagawa, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/812,896

(22) Filed: Jun. 22, 2007

(30) Foreign Application Priority Data
Jul. 19, 2006 (JP) 2006-196995

(51) Int. Cl. G06K 15/00; H04N 1/04

(52) U.S. Cl. 358/1.16; 358/474

(57) ABSTRACT

Disclosed is an image processing apparatus including: a storage unit including a plurality of memory modules, the storage unit storing image data having been subjected to main scan shifting into the memory modules, wherein the storage unit is configured so that a memory module taking charge of a larger shifting amount at a time of sub scan shifting of the image data has a larger summation storage capacity; and a control unit selecting memory modules necessary for reading and writing the storage unit according to an inclination of the image data, and performing the reading and the writing of the image data into the selected memory modules.

### BACKGROUND OF THE INVENTION

1. Field of the Invention

The present invention relates to an image processing apparatus and an image reading apparatus.

2. Description of Related Art

A technique for forming an un-inclined image on a sheet of recording paper in a copier has been devised. The technique corrects the image data obtained by reading an inclined original at the time of reading an image by scanning the original in the main scanning direction and in the sub scanning direction.

As an method of the above original inclination correcting processing, there is a method of grasping image data as a collection of linear data in the main scanning direction or a collection of linear data in the sub scanning direction, and of combining the main scan shifting processing of shifting the linear data constituting an image in the main scanning direction into the main scanning direction (lateral direction) with the sub scan shifting processing of shifting the linear data in the sub scanning direction into the sub scanning direction (longitudinal direction) (see, for example, JP-2000-59611A).

There has also been devised a configuration of securing a minimum required rectangular memory region as an input buffer and of selecting data in the input buffer according to an inclined angle to correct the selected data in the sub scan shifting processing (see, for example, JP Hei 7-79321A).

FIG. 19 shows an outline of conventional sub scan shifting processing. As shown in FIG. 19, a case where inclined image data 200 after main scan shifting processing is subjected to sub scan shifting is examined. The image data corresponding to a rectangular memory region 230 for predetermined lines is stored in a first-in first-out (FIFO) memory, and the image data in a reading region 231 in the memory region 230 is read out of the stored image data. The inclination of the reading region 231 corresponds to the inclination of the image data 200. After the reading of the image data in the reading region 231 is performed, the memory region 230 is shifted into the sub scanning direction (the downward direction in the figure) for one pixel. By repeating this process, the image data of one sheet of image the inclination of which is corrected is obtained.

In the main scan shifting processing and the sub scan shifting processing, the correction is performed by the pixel. An error of one pixel or less is accordingly interpolated by interpolation processing after each shifting processing.

However, a further reduction of the storage capacity of the FIFO memory used for the sub scan shifting processing in the conventional inclination correction of image data is required.

As shown in FIG. 19, the rectangular memory region 230 includes a read region 232 and a delay region 233 with the reading region 231 as a border. The delay region 233 includes image data before reading. The read region 232 includes the image data that has been read in the reading region 231. The FIFO memory accordingly has a storage capacity for storing the memory region 230 including the unnecessary read region 232. The reduction of the cost of the FIFO memory by reducing the storage capacity of the FIFO memory is thus required.

In order to prevent the enlargement of the storage capacity of the FIFO memory, multileveling processing has been performed before the sub scan shifting processing to reduce the number of bits of image data, and then error diffusion processing and the like have been performed. Consequently, even if a FIFO memory having the same storage capacity is used, it is required not to perform the multileveling processing at the time of the sub scan shifting processing in order to correctly reproduce the pattern of the error diffusion and the like.

In order to solve the above problem, a configuration of storing only the reading region 231 and the delay region 233 into the FIFO memory to be used for the sub scan shifting processing to reduce the storage capacity thereof, and of performing the multileveling processing after the sub scan shifting processing was also devised. In this case, the capacity of the FIFO memory also increases according to the number of gradations of image data and an inclination correction ability.

Because the whole memory of the FIFO memory is always driven, the power consumption of the memory also increases according to the increase of the memory capacity. The reduction of the power consumption is accordingly required. Because the increase of the power consumption of a memory also increases the calorific value thereof, there is also a problem of the difficulty of installing the memory into an application specific integrated circuit (ASIC).

### SUMMARY OF THE INVENTION

It is an object of the present invention to reduce the storage capacity of a memory to be used for sub scan shifting and to reduce the power consumption and the calorific value of the memory.

To achieve at least one of the abovementioned objects, an image processing apparatus reflecting one aspect of the present invention comprises:

a storage unit including a plurality of memory modules, the storage unit storing image data having been subjected to main scan shifting into the memory modules, wherein the storage unit is configured so that a memory module taking charge of a larger shifting amount at a time of sub scan shifting of the image data has a larger summation storage capacity; and

a control unit selecting memory modules necessary for reading and writing the storage unit according to an inclination of the image data, and performing the reading and the writing of the image data into the selected memory modules.

In the above image processing apparatus, preferably, the memory modules are separately arranged in a plurality of regions with regard to a main scanning direction, and one of the plurality of regions is selected to be driven; and the control unit sequentially selects one of the plurality of regions in the main scanning direction to perform the reading and the writing of the image data.

Preferably, in the above image processing apparatus, the control unit circularly selects the memory modules to which the reading and the writing of the image data are performed according to the shifting amount of the sub scan shifting.

Preferably, the control unit includes: a sub scan shifting control unit outputting an address in one direction for the reading and the writing of the storage unit; a counter unit counting a counted value indicating a circulation amount according to the shifting amount of the sub scan shifting; and a first selector selecting the counted value to output the selected counted value as an address in another direction for the reading and the writing of the storage unit.

Preferably, the counter unit is arranged according to a position of the main scanning direction, and the counter unit includes a plurality of counters outputting counted values according to the shifting amount of the sub scan shifting according to the position of the main scanning direction.

Preferably, the image processing apparatus further comprises a second selector switching image data input after being subjected to the main scan shifting processing and image data read from the storage unit to output the switched image data.

### BRIEF DESCRIPTION OF THE DRAWINGS

The present invention will become more fully understood from the detailed description given hereinafter and the accompanying drawings, and these are not intended to limit the present invention, and wherein:

FIG. 1 is a view showing the mechanical configuration of a digital copier 1 of an embodiment according to the present invention;

FIG. 2 is a block diagram showing the electric configuration of an image reading apparatus;

FIG. 3 is a block diagram showing the internal configuration of an inclination correction processing unit;

FIG. 4 is a diagram showing the internal configuration of a sub scanning shift processing unit;

FIG. 5 is a diagram showing the arrangement of memory modules in the storage unit and the selection of the memory modules;

FIG. 6A is a diagram showing image data after image reading;

FIG. 6B is a diagram showing image data after main scanning shift processing;

FIG. 6C is a diagram showing image data after sub scanning shift processing;

FIG. 7A is a diagram showing the configuration of the image data;

FIG. 7B is a diagram showing the configuration of the image data;

FIG. 8A is a diagram showing a rectangular region in the sub scanning shift processing;

FIG. 8B is a diagram showing a reading region in the rectangular region;

FIG. 8C is a diagram showing a reading procedure in the reading region;

FIG. 8D is a diagram showing reading data;

FIGS. 9A to 9C are diagrams showing the state of a movement of a memory region;

FIG. 10A is a diagram showing the memory region in the case where an inclination angle δ is positive;

FIG. 10B is a diagram showing the memory modules in the storage unit in the case where the inclination angle δ is positive;

FIG. 11A is a diagram showing a memory region in the case where the inclination angle δ is negative;

FIG. 11B is a diagram showing the memory modules of the storage unit in the case where the inclination angle δ is negative;

FIG. 12 is a diagram showing the memory modules of the storage unit and counter signals in the case where the inclination angle δ is negative and a coefficient stair V=2;

FIG. 13 is a diagram showing the memory modules of the storage unit and the counter signals in the case where the inclination angle δ is negative and the coefficient stair V=3;

FIG. 14 is a flow chart showing copying processing;

FIG. 15 is a timing chart of the signals to be used in the sub scanning shift processing unit in the case where the inclination angle δ is negative and the coefficient stair V=2;

FIGS. 16A to 16H are diagrams showing a transition of the data reading and the data writing of the memory modules of the storage unit 3250 in the case where the inclination angle δ is negative and the coefficient stair V=2;

FIGS. 17A to 17F are diagrams showing a transition of the data reading and the data writing of the memory modules of the storage unit in the case where the inclination angle δ is negative and the coefficient stair V=3;

FIG. 18 is a diagrams showing another example of the arrangement of the memory modules of the storage unit; and

FIG. 19 is a schematic diagram showing conventional sub scanning shift processing.

### DETAILED DESCRIPTION OF THE PREFERRED EMBODIMENTS

In the following, an embodiment according to the present invention will be described in detail with reference to the attached drawings. The scope of the present invention is not limited to the shown examples, however.

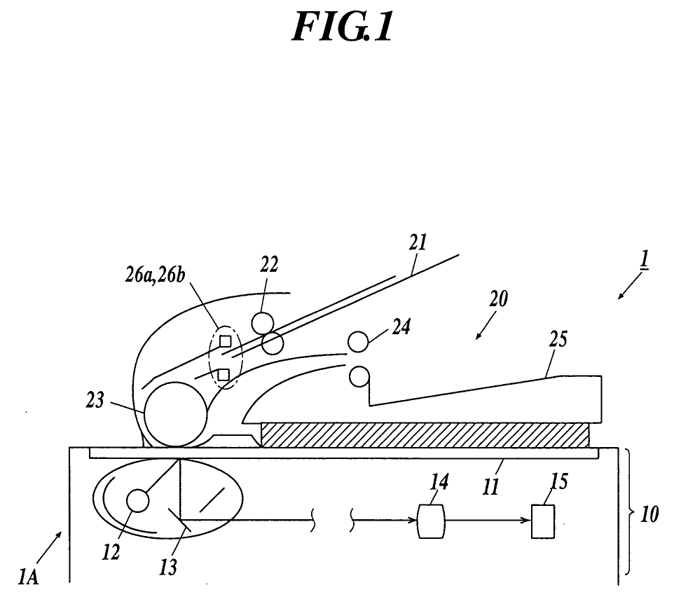

First, the apparatus configuration of a digital copier 1 of the present embodiment will be described with reference to FIGS. 1-4. FIG. 1 shows the mechanical configuration of the digital copier 1 of the present embodiment.

The digital copier 1 is configured to include a copier main body 1A and an original conveyance unit 20. The original conveyance unit 20 is formed to be a separate unit from the copier main body 1A and is attached to the copier main body 1A.

The copier main body 1A includes a scanner 10 as an image reading apparatus. The scanner 10 is configured to include an original placing pedestal 11, an original light source 12, a mirror 13, an image formation lens 14, and a line sensor 15. The copier main body 1A is configured to include a main body control unit 60, and operation unit 70, a printer unit 50, and the like, as described later.

An original the image of which is to be read is placed on the original placing pedestal 11, and the original placing pedestal 11 forms a passage of the original and an illumination position of the original at the time of reading the moving original. The original light source 12 can freely move along the original placing pedestal 11 to output light. The mirror 13 can freely move together with the original light source 12. The image formation lens 14 focuses incident light onto the line sensor 15. The line sensor 15 is made of a charge coupled device (CCD) or the like, and converts an input optical signal into an electric signal to output the electric signal.

The light output from the original light source 12 is reflected by the original to enter the line sensor 15 through the mirror 13 and the image formation lens 14.

The original conveyance unit 20 includes a paper feed tray 21, paper feed rollers 22, a roller 23, paper ejecting rollers 24, a copy receiving tray 25, and sensors 26a and 26b.

The originals the images of which are to be read are placed on the paper feed tray 21. The paper feed rollers 22 convey the originals placed on the paper feed tray 21 one by one. The roller 23 conveys the original conveyed by the paper feed rollers 22 to the reading position, and further conveys the original into a certain direction at the reading position. The paper ejecting rollers 24 eject the original conveyed by the roller 23. The ejected original is placed on the copy receiving tray 25.

The sensors 26a and 26b are a light emitter and a light receiver, respectively, and detect the passing of an original. The sensors 26a and 26b are provided just behind the paper feed rollers 22 so as to cross an original conveyance path at a right angle to the original conveyance direction with the original conveyance path put between the sensors 26a and 26b.

The originals on the paper feed tray 21 is separated on by one by the paper feed rollers 22, and pass the roller 23 and the paper ejecting rollers 24 to be sent to the copy receiving tray 25.

The line sensor 15 scans the original passing through the reading position formed by the original placing pedestal 11 and the roller 23 in the main scanning direction, which is the direction of the line, and in the sub scanning direction, which is the movement direction of the original, and the image reading by the original movement system is performed.

The digital copier 1 can also perform the image reading by the original resting system. That is, the image reading can be performed also by moving the original light source 12 and the mirror 13 to the original placed on the original placing pedestal 11.

The sensors 26a and 26b detect the angle of the leading edge of the original conveyed along the original conveyance path, that is, the sensors 26a and 26b detects the inclination of the original while the original is traveling in the original conveyance unit 20. Incidentally, an arbitrary known sensor can be used as the sensor for detecting the inclination of the original.

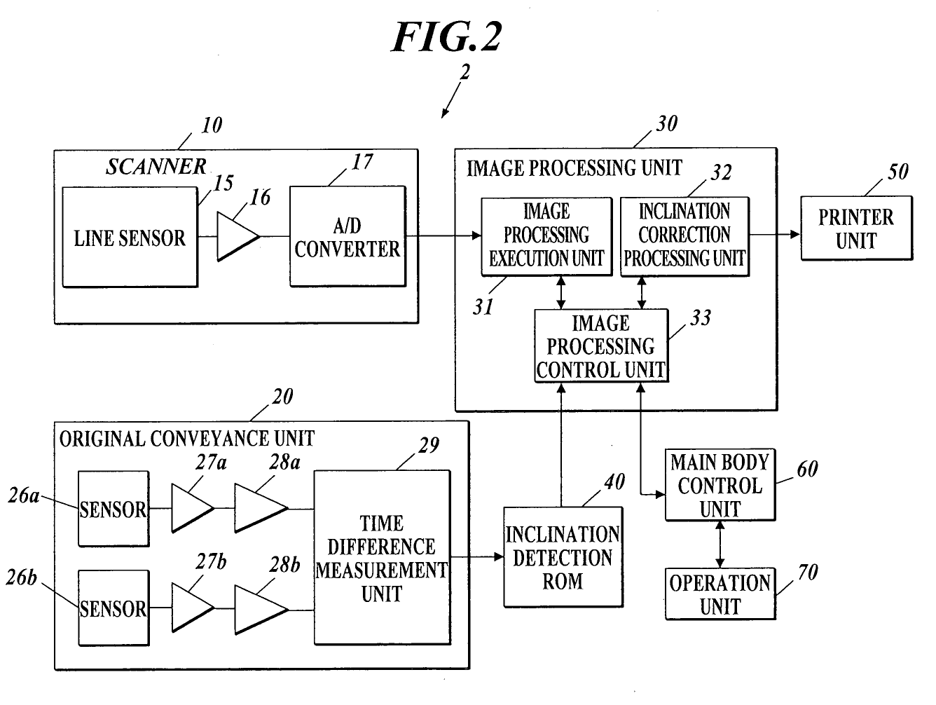

FIG. 2 shows the electric configuration of an image reading apparatus 2. As shown in FIG. 2, the image reading apparatus 2 is an apparatus for reading an original image, and is provided in the digital copier 1.

As shown in FIG. 2, the image reading apparatus 2 is configured to include the scanner 10, the original conveyance unit 20, an image processing unit 30, and an inclination detection read only memory (ROM) 40. Moreover, the digital copier 1 is configured to include the printer unit 50, the main body control unit 60, and the operation unit 70 besides the image reading apparatus 2.

The scanner 10 reads an original image, and outputs the image data thereof. The scanner 10 is configured to include an amplifier 16 and an A/D converter 17 besides the line sensor 15 and the like. The amplifier 16 amplifies an electric signal output from the line sensor 15. The A/D converter 17 converts an analog electric signal output from the amplifier 16 into digital image data, and outputs the digital image data.

The original conveyance unit 20 is configured to include amplifiers 27a and 27b, comparators 28a and 28b, and a time difference measurement unit 29 besides the sensors 26a and 26b, and the like. The amplifiers 27a and 27b amplify the outputs of the sensors 26a and 26b. The comparators 28a and 28b compare the outputs of the amplifiers 27a and 27b with a threshold value, and output signals corresponding to the passing times of the leading edge of the original. The time difference measurement unit 29 calculates the time difference between the outputs of the comparators 28a and 28b, and outputs the calculated time difference.

In the original conveyance unit 20, the sensors 26a and 26b detect the information of the inclination angle θ of the conveyed original in the main scanning direction, and the time difference measurement unit 29 calculates the time difference. If the distance between the sensors 26a and 26b is denoted by d, and if the conveyance speed of the original is denoted by v, then the inclination angle θ is expressed by the following formula (1):

θ=tan⁻¹(s·v/d) (1)

The inclination detection ROM 40 stores the relations between stair H and stair V, the time differences, and the inclination angles θ, respectively, which stair H and stair V are expressed by the following formulae (2) and (3):

stair H=(int)(1/tan θ) (2)

stair V=(int)(1/tan δ) (3)

In the formulae (2) and (3), (int) indicates the conversion to be an integer by truncating the numbers after the decimal point, and δ indicates the angle obtained by converting the inclination angle θ of an original by the main scanning shift processing, which will be described later, to be expressed by the following formula (4):

δ=tan⁻¹ {1/(tan θ+1/tan θ)} (4)

The stair H is the number of pixels indicating that the pixel distant from a certain pixel set as the origin into the sub scanning direction by the number of pixels is needed to be shifted by one pixel into the main scanning direction in order to remove the inclination of the image. The stair V is the number of pixels indicating that the pixel distant from a certain pixel set as the origin into the main scanning direction by the number of pixels is needed to be shifted by one pixel into the sub scanning direction in order to remove the inclination of the image.

The image processing unit 30 performs various kinds of image processing to the image data output from the scanner 10. The image processing unit 30 is configured to include an image processing execution unit 31, an inclination correction processing unit 32, and an image processing control unit 33. The image processing execution unit 31 performs filtering processing, variable power processing, and the like to the image data that is the data for one line in the main scanning direction which data is serially output into the sub scanning direction every pixel from the scanner 10 based on the control of the image processing control unit 33. The inclination correction processing unit 32 performs inclination correction processing and interpolation processing in the main scanning direction and the sub scanning direction to the image data after being subjected to the image processing which image data is output from the image processing execution unit 31, based on the control of the image processing control unit 33.

The image processing control unit 33 includes a central processing unit (CPU), a random access memory (RAM), and a read only memory (ROM). In the image processing control unit 33, various programs read from the ROM are expanded in the RAM, and various kinds of processing are executed by the cooperation of programs and the CPU on the RAM.

The image processing control unit 33 controls the image processing execution unit 31 and the inclination correction processing unit 32 based on the control of the main body control unit 60. Moreover, the image processing control unit 33 calculates the stair H and the stair V based on the time difference and the angle θ, both output from the original conveyance unit 20, and the information stored in the inclination detection ROM 40. The image processing control unit 33 controls the inclination correction processing unit 32 using the stair H and the stair V.

The printer unit 50 performs printing (image formation) on a recording medium, such as recording paper, based on the image data output from the image processing unit 30. The printing system of the printer unit 50 is an electrophotography system, an ink-jet system, a thermal transfer system, and the like.

The operation unit 70 is provided with various keys, and receives user's operation inputs to output the input information to the main body control unit 60. Moreover, the operation unit 70 is provided with a display unit, such as a liquid crystal display (LCD), and performs display based on the display information input from the main body control unit 60. The operation unit 70 may be configured as a touch panel integrally with the display unit. The operation unit 70 receives the setting inputs of print conditions, such as the variable power and the image quality of image data.

The main body control unit 60 includes a CPU, a RAM, and a ROM. In the main body control unit 60, various kinds of processing are executed by the cooperation of various programs read from the ROM and expanded into the RAM and the CPU. The main body control unit 60 performs the central control of each unit, such as the image processing control unit 33, in the inside of the digital copier 1. The main body control unit 60 especially performs the copying processing, which will be described later, based on a copying program.

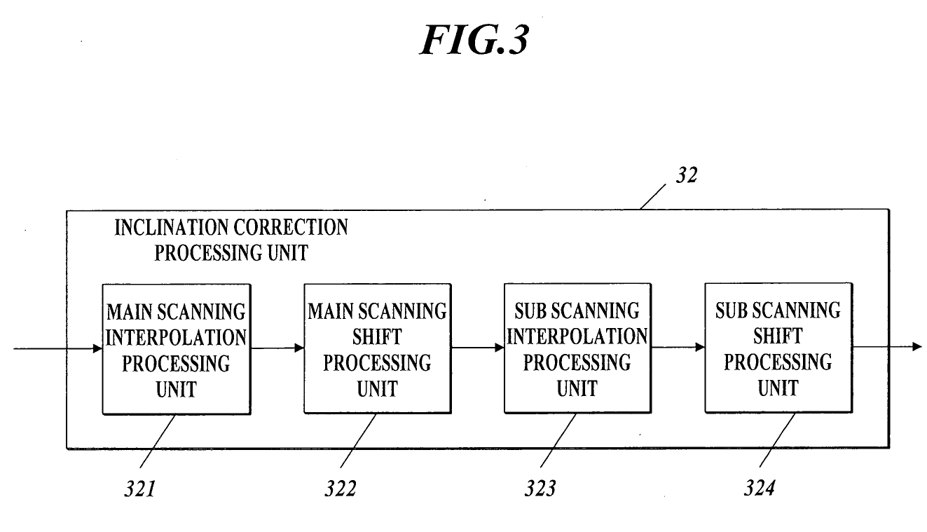

FIG. 3 shows the internal configuration of the inclination correction processing unit 32. As show in FIG. 3, the inclination correction processing unit 32 is configured to include a main scanning interpolation processing unit 321, a main scanning shift processing unit 322, a sub scanning interpolation processing unit 323, and a sub scanning shift processing unit 324.

The main scanning interpolation processing unit 321 performs main scanning interpolation processing to the image data output from the image processing execution unit 31, and outputs the processed data. The main scanning shift processing unit 322 performs the main scanning shift processing to the image data output from the main scanning interpolation processing unit 321, and outputs the processed data. The main scanning shift processing unit 322 includes a not shown line memory, and stores each line data of image data into the line memory. The main scanning shift processing unit 322 then performs the shift of each line in the main scanning direction by the position adjustment of the line data in the line memory.

The sub scanning interpolation processing unit 323 performs sub scanning interpolation processing to the image data output from the main scanning shift processing unit 322, and outputs the processed data. The sub scanning shift processing unit 324 performs the sub scanning shift processing to the image data output from the sub scanning interpolation processing unit 323, and outputs the processed data.

FIG. 4 shows the internal configuration of the sub scanning shift processing unit 324. In the present embodiment, the configuration in which the sub scanning shift processing unit 324 can shift six pixels at the maximum into the sub scanning direction in the sub scanning shift processing is supposed. The present invention is not limited to the configuration of the shift amount, however.

As shown in FIG. 4, the sub scanning shift processing unit 324 is configured to include a control unit 3240, a comparator 3249, a storage unit 3250, and a selector 3251 as a second selector. The control unit 3240 is configured to include a sub scanning shift control unit 3241, counters 3242-3247, and a selector 3248 as a first selector.

Although it is not shown in FIG. 4, the sub scanning shift processing unit 324 includes a signal generation unit outputting a main scanning effective signal HVI, a sub scanning effective signal VVI, and a main scanning synchronization signal INDI, all described later, by the control of the image processing control unit 33.

The sub scanning shift control unit 3241 operates based on a clock signal (not shown); generates a selection signal sel and an address signal adr based on the main scanning effective signal HVI input from the signal generation unit and the coefficient stair V input from the image processing control unit 33; outputs the selection signal sel to the selector 3248 and the comparator 3249; and outputs the address signal adr to the storage unit 3250.

The main scanning effective signal HVI is a positive logic binary signal, and indicates whether the data signal DI output from the image processing execution unit 31 is effective or not. The selection signal sel is a control signal for the input switching of the selector 3248. The address signal adr is a signal for specifying an address of the storage unit 3250. The lower-order bits of the address signal adr are input into the storage unit 3250 as an address signal X indicating an address of the storage unit 3250 in the X direction. The higher-order bits of the address signal adr are input into the storage unit 3250 as a selection signal CS of the storage unit 3250.

The sub scanning effective signal VVI and the main scanning synchronization signal INDI are input into each of the counters 3242-3247; and signals CNT2-CNT7 are output from the counters 3242-3247, respectively. The sub scanning effective signal VVI is a sub scanning effective signal indicating whether a sub scanning shift is effective or not by the positive logic. The main scanning synchronization signal INDI is a signal taking the high level for a predetermined time in each main scanning line. The counter signals CNT2-CNT7 are signals indicating the address of each memory region of the storage unit 3250 in the Y direction, and becomes the counted values circulating within the range of shift quantities in the sub scanning direction. That is, the counters 3242-3247 severally count the number of times of the high level of the main scanning synchronization signal INDI, and circulate within the range of the shift quantities in the sub scanning direction to output the counter signals CNT2-CNT7.

The selector 3248 selects one of the counter signals CNT2-CNT7 input from the counters 3242-3247, respectively, based on the selection signal sel, and outputs the selected signal as an address signal Y indicating the address of the storage unit 3250 in the Y direction. To put it concretely, the selector 3248 outputs 0 in the case of selection signal sel=0, and outputs each of the counter signals CNT1 (=0: fixed) and CNT2-CNT7 in the case of the selection signal sel=1.

The comparator 3249 compares the selection signal sel with 0, and outputs a selection signal s, which takes the level 0 in the case of the selection signal sel≠0 or the level 1 in the case of the selection signal sel=0. The storage unit 3250 is a memory including a plurality of memory modules and capable of specifying a memory module to be driven, and is formed of a RAM or the like. The storage unit 3250 outputs a data signal DO based on the address signal X and the selection signal CS, both input from the sub scanning shift control unit 3241, a clock signal CLK, and the data signal DI.

The selector 3251 outputs a definitive data signal DO based on the selection signal s input from the comparator 3249, the data signal DO input from the storage unit 3250, and the data signal DI. To put it concretely, the selector 3251 outputs the data signal DO from the storage unit 3250 in the case of the selection signal s=0, and outputs the data signal DI as the data signal DO in the case where the selection signal s=1. Moreover, the data signal DO is a data signal output from the inclination correction processing unit 32.

FIG. 5 shows the arrangement of memory modules in the storage unit 3250 and the selection of the memory modules. As shown in FIG. 5, an address X and an address Y are set to each memory module of the storage unit 3250. Moreover, each memory unit shown as a regular square in FIG. 5 is supposed to correspond to one pixel. Each memory module is expressed by solid lines in FIG. 5, and is a memory region consisting of two pixels in the main scanning direction as a set. Each memory module of the storage unit 3250 of FIG. 5 is the one in the case where the inclination angle δ is negative and the coefficient stair V is 2. Each memory region of the storage unit 3250 of FIG. 5 is the one arranged correspondingly to an address X and an address Y, and is not the one that is physically arranged. Consequently, all the regular square memory units shown in FIG. 5 are the memories of the storage unit 3250.

The storage unit 3250 is divided into the main scanning direction by the selection signal CS, and includes a memory module group divided in the sub scanning direction by the pixel. Only the memory module corresponding to the selection signal CS is driven. The memory modules driven at the same time is, that is, one of the memory module group divided by the selection signal CS in the main scanning direction. As shown in FIG. 5, for example, in the case of the selection signal CS=5, only the memory modules (the ones colored to be gray) corresponding to the selection signal CS=5 among the respective memory modules of the storage unit 3250 are driven. The power consumption can be consequently reduced in comparison with the case where all of the memory modules of the storage unit 3250 are driven, and the calorific value in this case can be also reduced. In FIG. 5, the power consumption becomes ¼ in comparison with the case where all of the memory modules are driven even if the memory modules to be driven are (the selection signal CS=7) at the maximum.

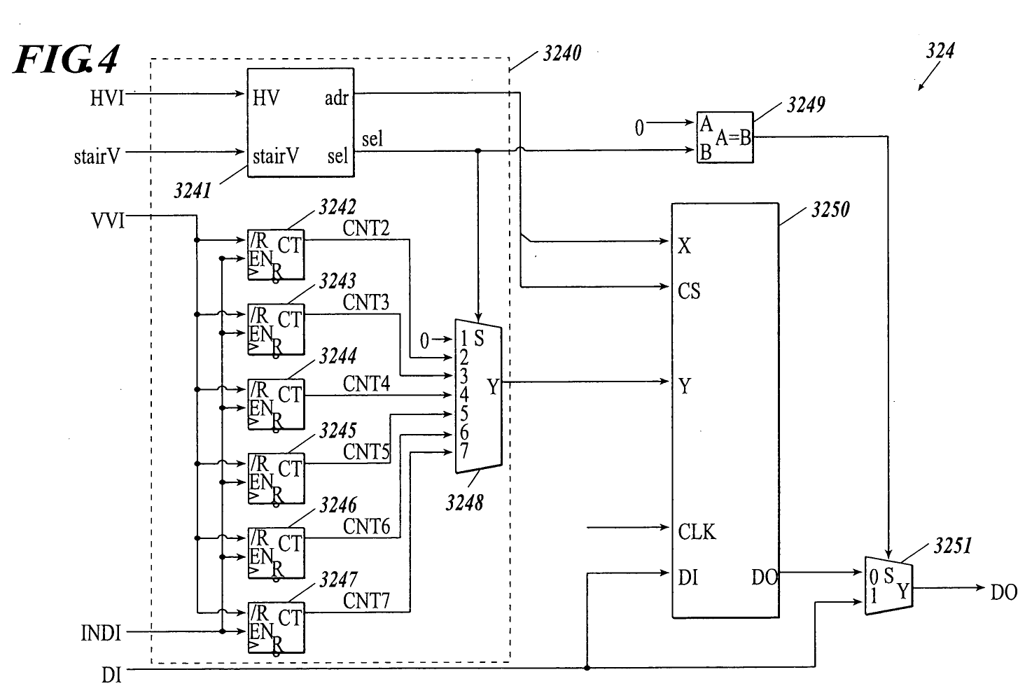

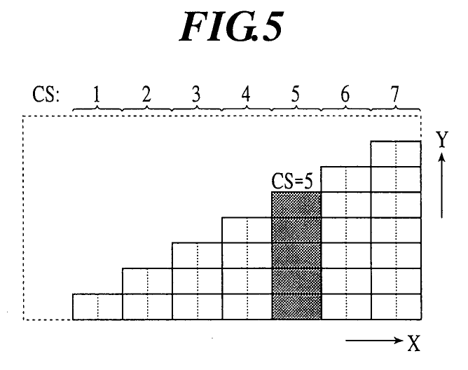

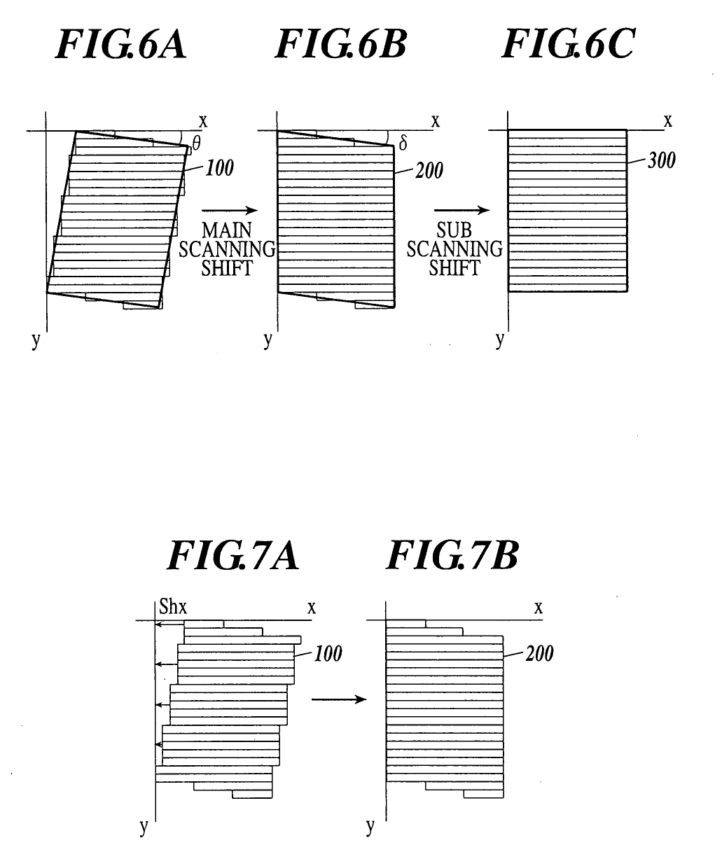

Next, the operation of the digital copier 1 will be described. First, the outlines of the main scanning shift processing and the sub scanning shift processing will be described. FIGS. 6A-6C show the concept of the main scanning shift processing and the sub scanning shift processing. FIG. 6A shows image data 100 after being subjected to image reading. FIG. 6B shows image data 200 after being subjected to main scanning shift processing. FIG. 6C shows image data 300 after being subjected to sub scanning shift processing.

As shown in FIG. 6A, the scanner 10 reads an inclined original, and obtains the image data 100 as a collection of horizontal line-like data. In the following, it is supposed that an x axis is taken in the main scanning direction and y axis is taken in the sub scanning direction. It is further supposed that the angle formed by the image data 100 and the x axis is denoted as an angle θ.

The main scanning shift processing is the processing of shifting the pixels of the image data 100 into the main scanning direction every row, and is the correction processing for removing the inclinations of the vertical lines of the image data 100. The shift quantities are different from one another according to the positions on the y axis. As shown in FIG. 6B, the rectangular image data 100 receives the main scanning processing by the main scanning shift processing unit 322, and is changed to the parallelogram image data 200. The angle formed by the image data 200 and the x axis is supposed to be denoted as an angle δ.

The sub scanning shift processing is the processing of shifting the pixels of the image data 200 into the rectangular direction (sub scanning direction) to the direction (main scanning direction) in which the pixels have been shifted in the main scanning shift processing, and is the correction processing of making the angle δ of the image data inclined by the angle δ to the x axis 0. As shown in FIG. 6C, the image data 200 receives the sub scanning processing by the sub scanning shift processing unit 324 to be changed to the image data 300 of the angle δ=0.

Next, the main scanning interpolation processing, the main scanning shift processing, the sub scanning interpolation processing, and the sub scanning shift processing will be described in detail in order.

The main scanning interpolation processing is the processing of the main scanning interpolation processing unit 321 that is performed to the image data that has been read by the scanner 10 and has been output to the image processing execution unit 31. The vertical lines of the image data subjected to the main scanning shift processing are macroscopically seen as a vertically connected line. However, when it is seen by the pixel, an inclined line over two pixels is broken at a position where shift quantities are different from each other. Owing to such a discontinuity, the whole image is seen to have a jagged contour. The cause of this is that the main scanning shift is performed by the integer as described above.

The main scanning interpolation processing is the processing for correcting such deterioration of the image quality. The main scanning interpolation processing is set to the processing for correcting the pixel value of a watching pixel by, for example, calculating the weighted average of the pixel value of the watching pixel and the pixel value of the adjacent pixel based on the weighting according to the shift amount after the decimal point that has been truncated by the main scanning shift processing. In the main scanning interpolation processing, a main scanning interpolation amount is calculated using the stair H, and the interpolation processing is executed based on the main scanning interpolation amount.

The main scanning shift processing is the processing of the main scanning shift processing unit 322 which processing is performed to the image data output from the main scanning shift processing unit 322. FIG. 7A shows the configuration of the image data 100. FIG. 7B shows the configuration of the image data 200. As shown in FIGS. 7A and 7B, the case where the main scanning shift processing is performed to the image data 100 to change the image data 100 to the image data 200 will be examined.

In the main scanning shift processing, it is repeated that each line of the image data 100 is stored in the line memory and shifted into the main scanning direction to be read by the main scanning shift processing unit 322. As shown in the arrows in FIG. 7A, it is performed to shift the pixel values into the main scanning direction on the line memory in the main scanning shift processing unit 322 in order to shift the collection of the pixels of the image data 100 as shown by shx.

If the value of the number of pixels to be shifted into the main scanning direction on the yth line is denoted by the shx when the inclination of an original is supposed to be θ, then the shx is expressed by the following formula (5):

shx=y·tan θ (5)

Incidentally, the horizontal direction of a shift is distinguished by a sign.

In fact, because a shift cannot be performed only by the pixel, the shx is used as a main scanning shift amount ishx of the display by the pixel which amount ishx is defined by the following formula (6) of truncating the fractions of the shx:

ishx=(int)shx (6),

where (int) indicates changing the shx to an integer.

The formula (6) can be expressed as the following formula (7) by using the coefficient stair H supplied from the image processing control unit 33 (inclination detection ROM 40) in FIG. 2:

ishx=(int)(y/stair H) (7).

By shifting the pixel values on the line memory in accordance with the formula (7), the image data 100 shown in FIG. 7A is changed to the image data 200 shown in FIG. 7B, and the inclination in the main scanning direction is corrected to remove, for example, the inclinations of the vertical lines.

The sub scanning interpolation processing is the processing for correcting the pixel value of the image data the continuity of which is cut by the sub scanning shift processing, and is the processing for correcting the pixel value of a watching pixel by calculating the weighted average of the pixel value of the watching pixel and the pixel value of the adjacent pixel by using a weighting coefficient. In the sub scanning interpolation processing, a sub scanning interpolation amount is calculated using the stair V, and the interpolation processing is executed based on the sub scanning interpolation amount.

The sub scanning shift processing is the correction of shifting the pixels of the image data 200 into the sub scanning direction to make the angle δ of the image data 200 inclined by the angle δ to the y axis 0. The shift quantities of the sub scanning shift processing take different values according to the positions on the x axis.

The data processing for the sub scanning shift processing is the processing of obtaining the image data for one line by storing the image data of the memory region in the rectangular region for a plurality of lines into the storage unit 3250 and by giving the delay according to a position on the x axis.

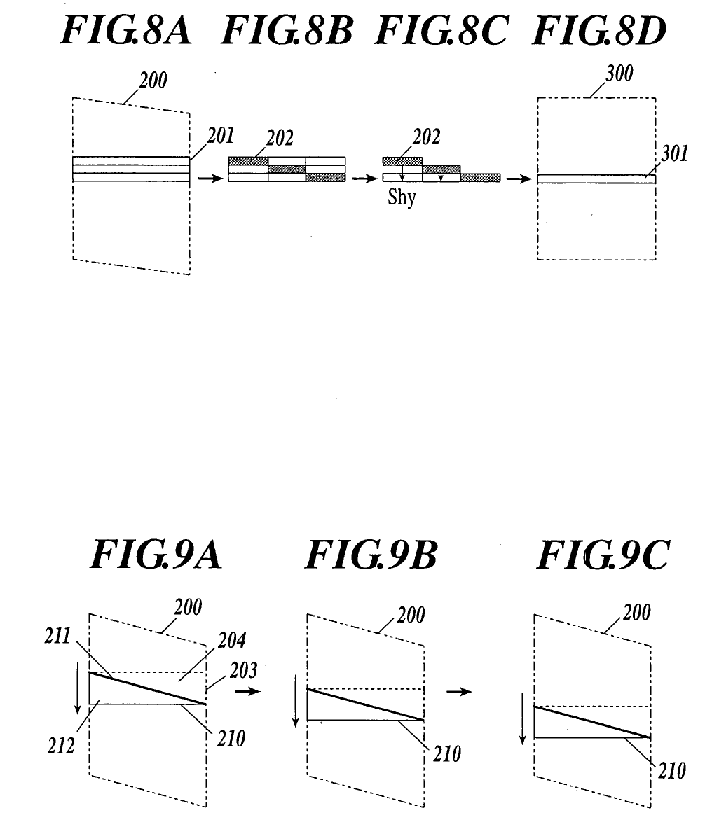

FIG. 8A shows a rectangular region 201 in the sub scanning shift processing. FIG. 8B shows a reading region 202 in the rectangular region 201. FIG. 8C shows a reading procedure in the reading region 202. FIG. 8D shows reading data 301. Incidentally, in the example of FIGS. 8A-8D, the rectangular region 201 is expressed to be composed of three lines.

For example, as shown in FIG. 8A, the rectangular region 201 is set in the image data 200. As shown in FIG. 8b, the reading region 202 corresponding to the inclination of the sub scanning direction is specified in the three-line rectangular region 201. Each line of the reading region 202 is read with a larger delay amount as the value of the x axis is smaller. As shown in FIG. 8D, the reading region 202 is read as the reading data 301 of one line having no inclinations. The rectangular region 201 moves to the lower part by the pixel every reading of the reading region 202 (reading data 301). Consequently, the reading data 301 of all the lines is collected to constitute the image data 300 shown in FIG. 6C.

When the inclination of the image data 200 to the x axis is set as the angle δ, the pixel value of a pixel located on the shy line from a watching line as for the pixel at the xth column. The watching line means the lowermost main scanning line in a reading region 211. The shy is a shift amount in the sub scanning direction. The relation between a coordinate value x and a shift amount shy can be expressed by the following formula (8):

$$\begin{matrix}shy = ( x 0 - x ) \cdot tan δ ( δ \text{:} positive ) \\ = x \cdot tan ( - δ ) ( δ \text{:} negative ) ,\end{matrix} \qquad ( 8 )$$

where, x0 is the length of the main scanning line of the image data 200. The processing is also performed by the integer here. Consequently, ishy, which is the integer changed from the shy, is used as the shift amount, and the ishy is expressed by the following formula (9). The main scanning shift amount ishy takes a positive value.

$$\begin{matrix}Ishy = ( int ) ( ( x 0 - x ) / stair V ) ( δ \text{:} positive ) \\ = ( int ) ( x / stair V ) ( δ \text{:} negative )\end{matrix} \qquad ( 9 )$$

By the sub scanning shift processing, the inclination of the original is corrected as shown in FIG. 6C, and a right image is reproduced.

FIGS. 9A-9C show the state of a movement of a memory region 210. As shown in FIGS. 9A-9C, a rectangular region 203 moves into the lower part by the pixel every reading of the reading region 211. The rectangular region 203 includes the reading region 211, a delay region 212, and a read region 204. In the present embodiment, only the reading region 211 and the delay region 212 on the lower side of the reading region 211 are stored in the storage unit 3250. The reading region 211 and the delay region 212 are set as the memory region 210. However, if the inclination angle δ is positive, then the region for the coefficient stair V on the most right side of the image data 200 is not correctly stored in the storage unit 3250, which will be described later.

The reason is that the image data of the read region 204 becomes unnecessary data after reading. The storage capacity necessary for the storage unit 3250 in the case of storing the image data in the memory region 210 consequently becomes about a half of the one in the case of storing the whole image data in the rectangular region 203. In this way, it becomes possible to suppress the storage capacity of the memory modules to the one suitable for incorporating the memory modules into a practical apparatus.

Because the memory region 210 is small, multileveling processing for decreasing the number of bits of image data at the front-end processes of the sub scanning shift processing is not executed. The multileveling processing is the processing of decreasing the number of bits of a pixel value, for example, the conversion of 8-bit image data to 2- or 4-bit image data, and is executed by a known processing method such as the error diffusion method and the dither method. The deterioration of image data by performing the multileveling processing can be consequently prevented.

As described in JP Hei 10-336425A, the image receives the variable power of a different magnification in the main scanning direction and in the sub scanning direction at the time of the main scanning shift processing and the sub scanning shift processing, respectively. In order to faithfully reproduce an original image not only in the angle thereof but also in the shape thereof, it is theoretically necessary to perform a variable power correction. However, because the original inclination that is caused in reading is actually small, the variable power influenced in the shift processing is very small, and the correction is not necessary to be performed.

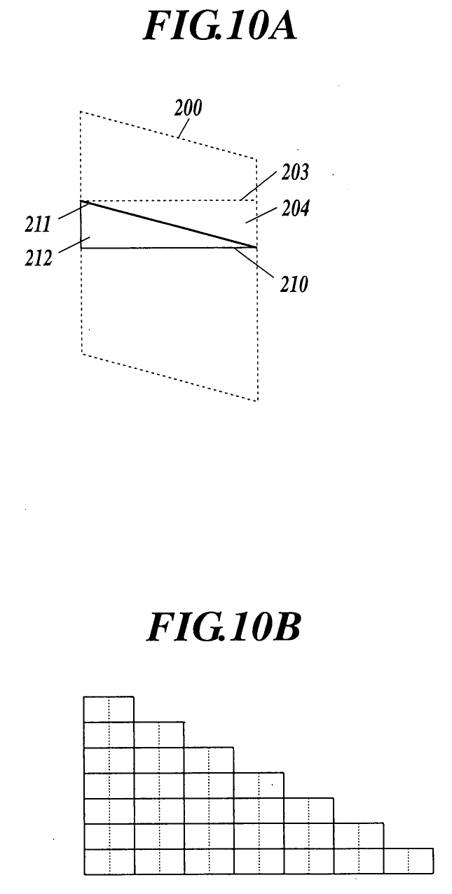

Next, the arrangement of the memory module of the storage unit 3250 will be described in each case of inclination angles δ of the image data 200 with reference to FIGS. 10A, 10B, 11A and 11B. FIG. 10A shows the memory region 210 in the case where the inclination angle δ is positive. FIG. 10B shows the memory modules of the storage unit 3250 in the case where the inclination angle δ is positive. FIG. 11A shows a memory region 220 in the case where the inclination angle δ is negative. FIG. 11B shows the memory modules of the storage unit 3250 where the inclination angle δ is negative.

First, the case where the angle δ is positive is examined. As shown in FIG. 10A, the rectangular region 203 therein contains the memory region 210 including the reading region 211 and the delay region 212 in the case where the inclination angle δ is positive. The memory modules of the storage unit 3250 shown in FIG. 10B are arranged in order to store the memory region 210 shown in FIG. 10A. The arrangement of the memory modules of the storage unit 3250 shown in FIG. 10B corresponds to the shape of the memory region 210, and the arrangement is set so that, as the sub scanning shift amount becomes larger, the number of the memory modules may become larger, and that the total storage capacity may consequently become larger.

Next, the case where the angle δ is negative will be examined. As shown in FIG. 11A, the rectangular region 203 contains the memory region 220 including a reading region 221 and a delay region 222 in the case where the inclination angle δ is negative. The memory modules of the storage unit 3250 shown in FIG. 11B are arranged in order to store the memory region 220 shown in FIG. 11A. The arrangement of the memory modules of the storage unit 3250 shown in FIG. 11B corresponds to the shape of the memory region 220, and the arrangement is set so that, as the sub scanning shift amount becomes larger, the number of the memory modules may become larger, and that the total storage capacity may consequently become larger.

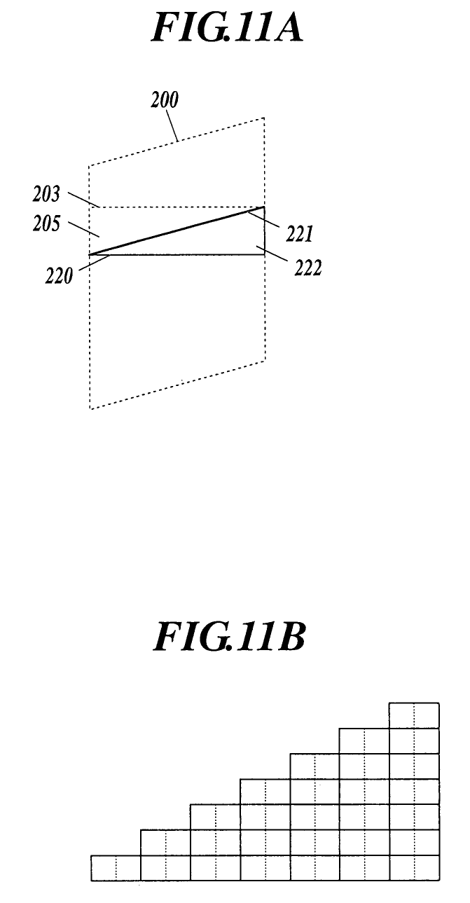

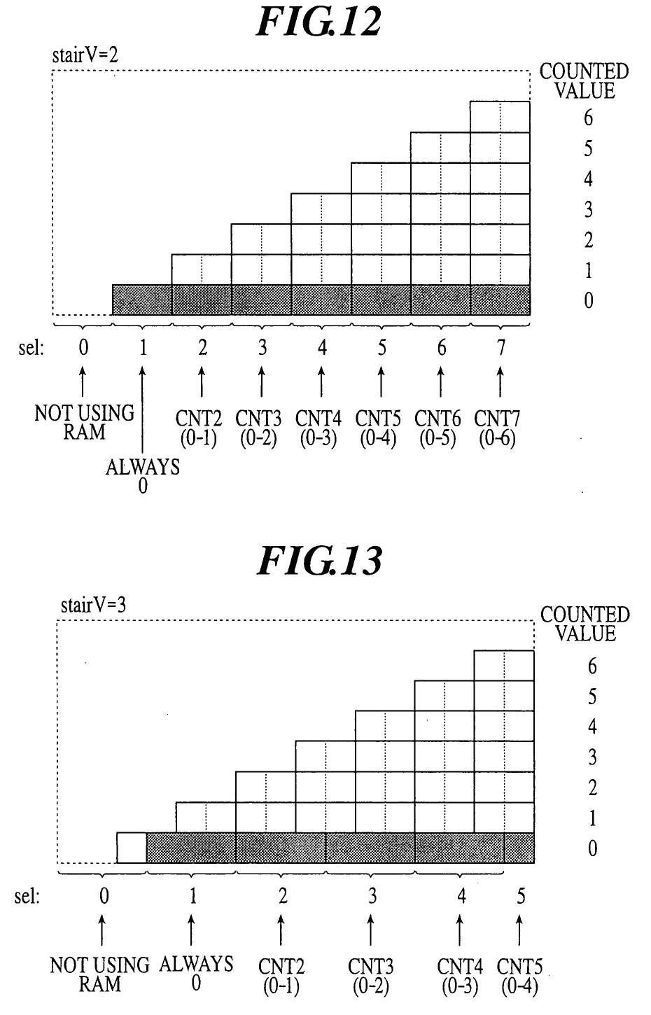

Next, the relations between the arrangement of the memory modules of the storage unit 3250 and the counter signals CNT2-CNT7 will be described correspondingly to the coefficient stair V in the case where the inclination angle δ of the image data 200 is negative with reference to FIGS. 12 and 13. FIG. 12 shows the memory modules of the storage unit 3250 and the counter signals in the case where the inclination angle δ is negative and the coefficient stair V is two. FIG. 13 shows the memory modules of the storage unit 3250 and the counter signals in the case where the inclination angle δ is negative and the coefficient stair V is three.

First, the memory modules of the storage unit 3250 in the case where the angle δ is negative and the coefficient stair V is two will be described. As shown in FIG. 12, each memory module at the address X is associated with any of the values (0-7) of the selection signal sel in the case of the coefficient stair V=2. The memory modules are associated with the selection signal sel by the block of two pixels in the main scanning direction. That is, this case is the one in which the memory module unit of the selection signal CS and the memory module unit of the selection signal sel agree with each other. The values of the selection signal sel correspond to the shift quantities (the counted values of the counters 3242-3247) into the sub scanning direction of image data.

To put it concretely, there are no memory modules corresponding to the selection signal sel=0, and the data signal DI is output from the sub scanning shift processing unit 324 as it is as the data signal DO. In the memory module corresponding to the selection signal sel=1, the address Y that is always 0 is input into the storage unit 3250, and the reading and the writing of image data are performed every reading of the image data on the main scanning line.

In the memory modules corresponding to the selection signal sel=2, the address Y corresponding to the counter signal CNT2 is input into the storage unit 3250, and the reading and the writing of image data are performed in the memory modules corresponding to the counted values (the circulation of 0-1) corresponding to the counter signal CNT2 every movement of the main scanning line. Similarly, in the memory modules corresponding to the selection signal sel=3, the address Y corresponding to the counter signal CNT3 is input into the storage unit 3250, and the reading and the writing of image data are performed in the memory modules corresponding to the counted values (the circulation of 0-2) corresponding to the counter signal CNT3 every movement of the main scanning line.

Similarly, in the memory modules corresponding to the selection signals sel=4-7, the addresses Y corresponding to the counter signals CNT4-CNT7 are input into the storage unit 3250, and the reading and the writing of image data are performed in the memory modules corresponding to the counted values (the circulation of 0-3, . . . , 0-6) corresponding to the counter signals CNT4-CNT7 every movement of the main scanning line.

The memory regions of the storage unit 3250 in the case where the angle δ is negative and the coefficient stair V is three will be examined. As shown in FIG. 13, each memory module at the address X is associated with any of the values (0-5) of the selection signal sel in the case of the coefficient stair V=3. The memory modules are associated with the selection signal sel by the block of three pixels in the main scanning direction. That is, this case is the one in which the memory module unit of the selection signal CS and the memory module unit of the selection signal sel do not agree with each other. The values of the selection signals sel correspond to the shift quantities (the counted values of the counters 3242-3247) into the sub scanning direction of image data.

Concretely, there are no memory modules corresponding to the selection signal sel=0, and the data signal DI is output from the sub scanning shift processing unit 324 as it is as the data signal DO. In the memory module corresponding to the selection signal sel=1, the reading and the writing of image data are performed every movement of the main scanning line in response to the input of the address Y that is always 0 into the storage unit 325.

In the memory modules corresponding to the selection signals sel=2-5, the addresses Y corresponding to the counter signals CNT2-CNT5 are input into the storage unit 3250, and the reading and the writing of image data are performed in the memory modules corresponding to the counted values (the circulation of 0-1, . . . , 0-4) corresponding to the counter signals CNT2-CNT5 every movement of the main scanning line.

In the case where the angle δ is positive, similarly, the memory modules of the storage unit 3250 are set according to the coefficient stair V.

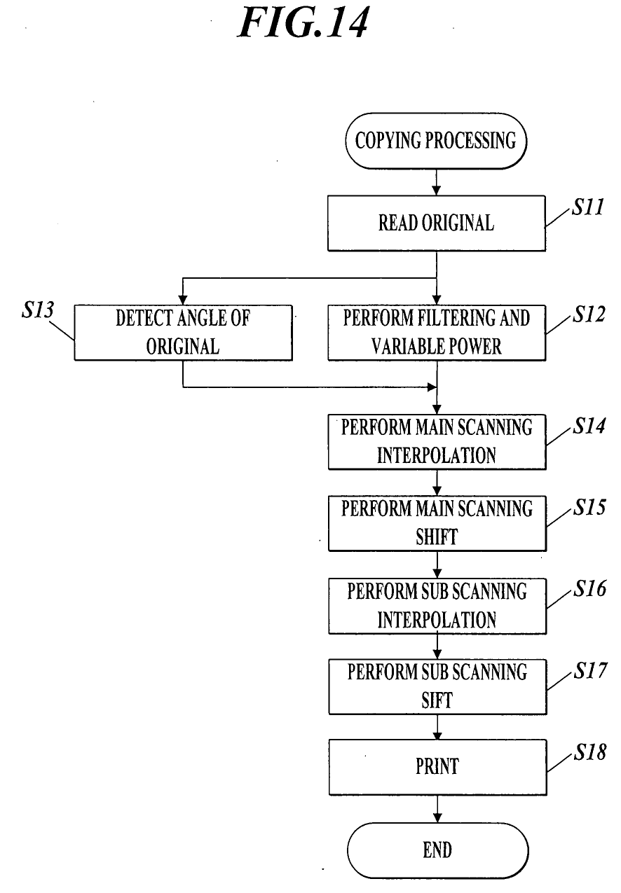

Next, copying processing executed in the digital copier 1 will be described with reference to FIG. 14. FIG. 14 shows the flow of the copying processing.

An original is set on the original conveyance unit 20 in advance. It is supposed that a setting input such as variable power from a user is received through the operation unit 70. The copying processing is executed by the main body control unit 60 by, for example, an input of a copying instruction from a user through the operation unit 70 as a trigger. In the main body control unit 60, the copying processing is executed by the cooperation of a copying program, which has been read from the ROM and has been expanded in the RAM, and the CPU.

First, the scanner 10 is controlled by the main body control unit 60. By the control, the original is read by the scanner 10, and image data is obtained (step S11). At this time, the original conveyance unit 20 is similarly controlled by the main body control unit 60, and time differences are calculated by the time difference measurement unit 29.

The image processing control unit 33 is then controlled by the main body control unit 60. The image processing execution unit 31 is controlled by the image processing control unit 33. The image processing such as filtering and variable power is performed to the image data output from the scanner 10 by the image processing execution unit 31 by the control (step S12).

The original inclination angle θ is detected by the image processing control unit 33 based on the time differences output from the formula (1) and the original conveyance unit 20 in parallel with the step S12 (step S13).

The formulae (2)-(4) are then read from the inclination detection ROM 40 by the image processing control unit 33, and the inclination angle δ, the stair H, and the stair V after a main scanning shift are calculated based on the relational formulae (2)-(4) and the angle θ. The main scanning interpolation processing is performed to the image data output from the image processing execution unit 31 using the stair H by the main scanning interpolation processing unit 321 (step S14).

The main scanning shift amount ishx is then calculated by the main scanning shift processing unit 322 based on the formulae (5)-(7), and the main scanning shift processing is performed to the image data output from the main scanning interpolation processing unit 321 using the main scanning shift amount ishx (step S15).

The sub scanning interpolation processing is performed to the image data output from the main scanning shift processing unit 322 by the sub scanning interpolation processing unit 323 using the stair V (step S16). The sub scanning shift processing by the sub scanning shift amount ishy is performed to the image data output from the sub scanning interpolation processing unit 323 by the sub scanning shift processing unit 324 using the coefficient stair V (step S17).

The printer unit 50 is then controlled by the main body control unit 60. The image of the image data output from the sub scanning shift processing unit 324 is recorded on a recording paper by the printer unit 50 (step S18). The copying processing then ends.

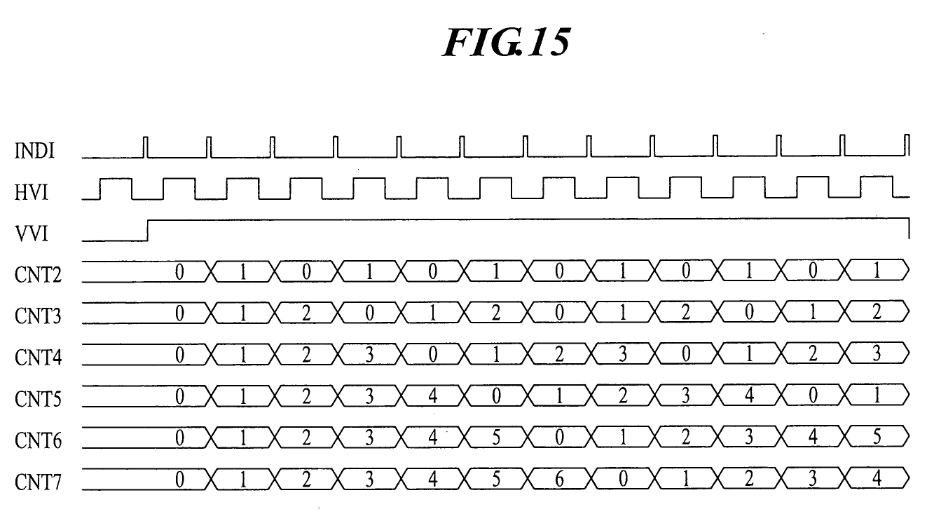

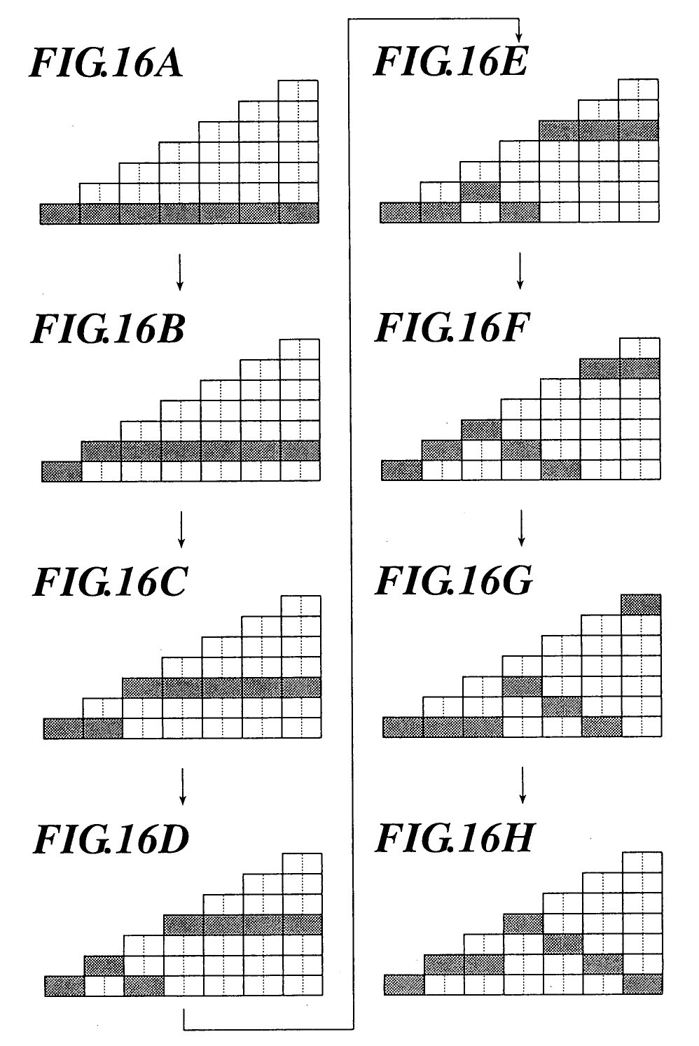

Next, the sub scanning shift processing at the step S17 in the copying processing will be described in detail with reference to FIGS. 15-17. FIG. 15 shows the flows of the timing of the signals of the signals to be used by the sub scanning shift processing unit 324 in the case where the inclination angle σ is negative and the coefficient stair V=2. FIGS. 16A-16H show the transitions of the data reading and the data writing of the memory modules of the storage unit 3250 in the case where the inclination angle δ is negative and the coefficient stair V=2. The memory modules of the storage unit 3250 are supposed to be reset every input of the image data 200.

First, the case where the inclination angle δ is negative and the coefficient stair V=2 will be examined. In the sub scanning shift processing, the address signal adr and the selection signal sel both corresponding to the coefficient stair V (=2) are output every input of the high level of the main scanning effective signal HVI as shown in FIG. 15. The sub scanning effective signal VVI and the main scanning synchronization signal INDI are input into the counters 3242-3247, the counted values corresponding to the present reading region are output.

Although it is not shown in FIG. 16A, the selection signal sel is 0 at the leftmost of the main scanning line, and the data signal DI is output as it is as the data signal DO through the selector 3251. Consequently, in the case where the inclination angle δ is negative, the region for the coefficient stair V at the leftmost of the image data 200 is configured not to be stored in the storage unit 3250. In the case where the inclination angle δ is positive, the region for the coefficient stair V for the rightmost of the image data 200 is configured not to be stored in the storage unit 3250.

Next, as shown in FIG. 16A, the selection signal sel becomes 1, and “0” is output from the selector 3248 to the storage unit 3250 as the address signal Y. In the storage unit 3250, the address signal X and the selection signal CS on the leftmost memory module, and the address signal Y are input, and the data stored in the memory module of the counted value 0 at the leftmost is read as the data signal DO through the selector 3251 based on the addresses X and Y, and the data signal DI is written in the memory region.

Next, the selection signal sel becomes 2, and the counter signal CNT2 is output from the selector 3248 to the storage unit 3250 as the address signal Y. The address signal X and the selection signal CS of the memory module at the second leftmost, and the address signal Y=CNT2 are input into the storage unit 3250, and the data that is stored in the memory module at the second leftmost, and in which the counted value is 0, is read based on the addresses X and Y to be output through the selector 3251 as the data signal DO. The data signal DI is written in the memory region.

Similarly the selection signal sel becomes 3 to 7 in order, and the counter signals CNT3-CNT7 are output from the selector 3248 to the storage unit 3250 as the address signal Y, respectively. The address signal X and the selection signal CS of the memory modules at the third to the seventh memory modules from the leftmost, and the address signals Y=CNT3-CNT7 are input into the storage unit 3250, and the data that is stored in the memory modules at the third to the seventh from the leftmost, and the counted value of which is 0, is read based on the addresses X and Y in order, respectively. The read data is output as the data signal DO through the selector 3251, and the data signal DI is written into the memory region. The data signal DO of the main scanning line after a sub scanning shift is thus output.

As shown in FIG. 16B, the processing shifts to the next main scanning line. First the selection signal sel is 0, and the data signal DI is output through the selector 3251 as it is as the data signal DO.

Next, the selection signal sel becomes 1, and “0” is output from the selector 3248 to the storage unit 3250 as the address signal Y. In the storage unit 3250, the address signal X and the selection signal CS on the leftmost memory module, and the address signal Y are input, and the data stored in the memory module of the counted value 0 at the leftmost is read as the data signal DO through the selector 3251 based on the addresses X and Y, and the data signal DI is written in the memory region.

Next, the selection signal sel becomes 2, and the counter signal CNT2 is output from the selector 3248 to the storage unit 3250 as the address signal Y. The address signal X and the selection signal CS of the memory module at the second leftmost, and the address signal Y=CNT2 are input into the storage unit 3250, and the data that is stored in the memory module at the second leftmost, and the counted value of which is 1, is read based on the addresses X and Y to be output through the selector 3251 as the data signal DO. The data signal DI is written in the memory region.

Similarly the selection signal sel becomes 3 to 7 in order, and the counter signals CNT3-CNT7 are output from the selector 3248 to the storage unit 3250 as the address signal Y, respectively. The address signal X and the selection signal CS of the memory modules at the third to the seventh memory modules from the leftmost, and the address signals Y=CNT3-CNT7 are input into the storage unit 3250, and the data that is stored in the memory modules at the third to the seventh from the leftmost, and the counted value of which is 0, is read based on the addresses X and Y in order, respectively. The read data is output as the data signal DO through the selector 3251, and the data signal DI is written into the memory region. The data signal DO of the main scanning line after a sub scanning shift is thus output.

In such a way, as shown in FIGS. 16A-16H, the data in the reading region 221 is read and written in order every shift of the main scanning line storage unit 3250 as for each memory module, and is being output as the image data of the main scanning line after the sub scanning shift. However, it is after the appearance of an image data value at the portion corresponding to the leftmost of the main scanning line that the image data of the main scanning line after the subs scanning shift is started to be output. As shown in FIG. 15 and FIGS. 16A-16H, the memory modules (by the two pixels) of the storage unit 3250 against which data reading and data writing are performed are selected so that each of the counter signals CNT2-CNT7 circulates in order in the circulation of 0-1, 0-2, 0-3, 0-4, 0-5, 0-6, and 0-7.

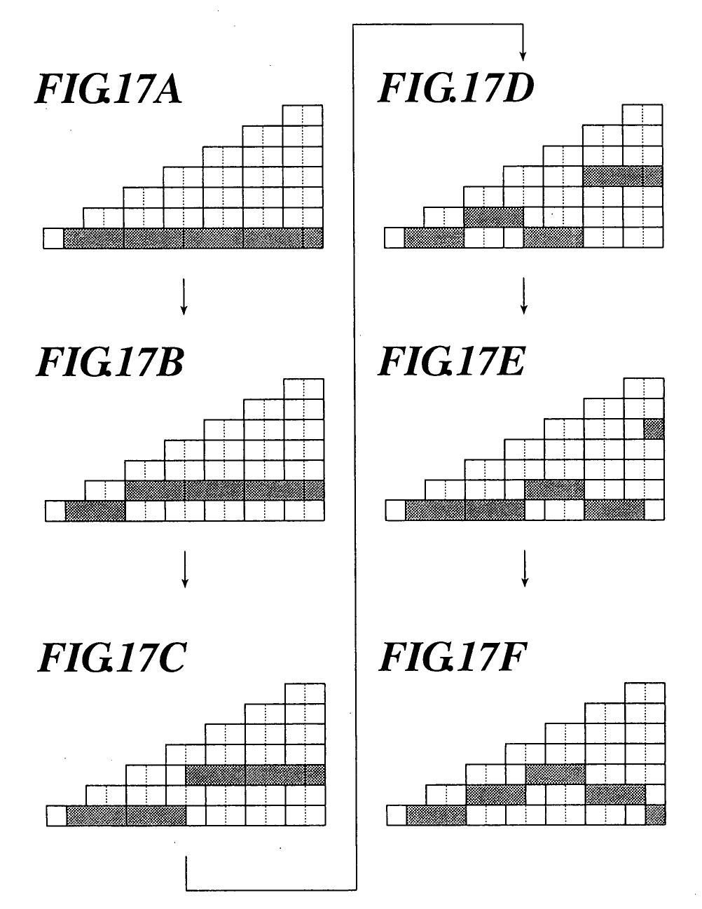

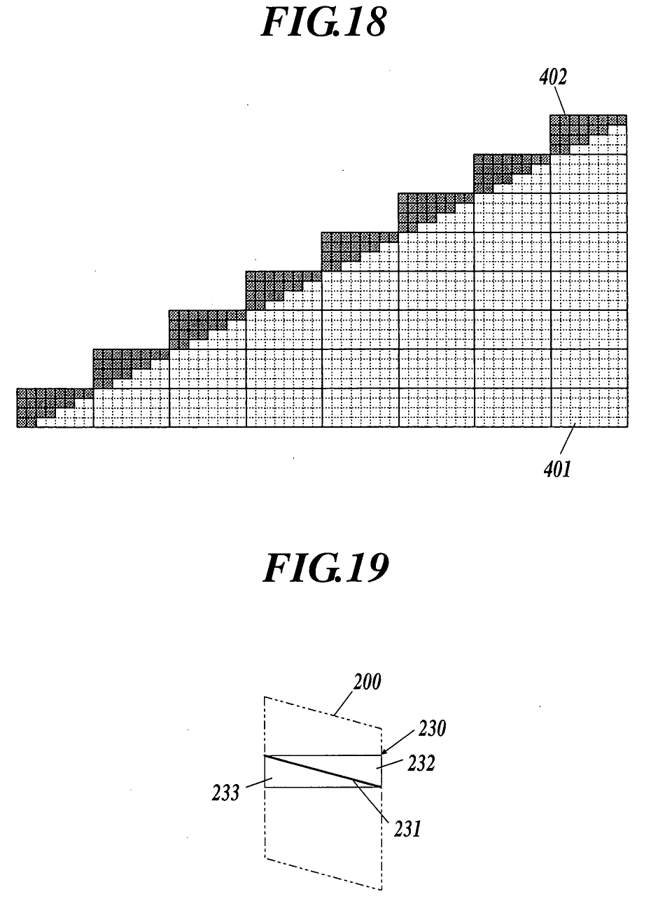

FIGS. 17A-17F show a transition of the data reading and the data writing of the memory modules of the storage unit 3250 in the case where the inclination angle δ is negative and the coefficient stair V=3. Similarly, the case where the inclination angle δ is negative and the coefficient stair V=3 will be examined. In the sub scanning shift processing, as shown in FIGS. 17A-17F, the memory modules (by the three pixels) of the storage unit 3250 against which data reading and data writing are performed are selected so that each of the counter signals CNT2-CNT5 circulates in order in the circulation of 0-1, 0-2, 0-3, 0-4, and 0-5.

Although the cases where the coefficient stair V=2 and 3 have been described here, the present invention is not limited to these cases, but the above descriptions are similarly true in any other values of the coefficient stair V. The sub scanning shift amount is changed accordingly to the inclination of the angle δ of the image data 200. Although the cases where the inclination angle δ is negative have been described, the present invention is not limited to these cases, but the case where the inclination angle δ is positive can be realized by the similar processing.

FIG. 18 shows another example of the arrangement of the memory modules of the storage unit 3250. Although the above descriptions have shown the cases of the mounting of performing the selection of the memory modules so as to be one pixel into the sub scanning direction and to be two pixels into the main scanning direction, it is not actually realistic to set the memory modules to be a certain degree or less in size. Even in the case where the storage unit 3250 is built in the ASIC, a control unit region and an electric power source unit region become necessary to every memory module in the storage unit 3250 which memory module can be driven and specified. Consequently, the region in the ASIC can be set to be smaller if the number of the memory modules to be selected is made to be smaller by forming the size of each of the memory modules to be as large as possible. That is the reason of the unreality of the smaller size of each memory module.

When the memory module unit to be selected is accordingly made to be large as, for example, a memory module 401 shown in FIG. 18, then some memory un-use regions 402 arises according to the number of divisions. However, the situation is also true in the conventional case of performing the sub scanning shift processing using a FIFO memory similarly.

As described above, according to the present embodiment, the storage capacity of the storage unit 3250 is made to correspond not to the rectangular region 203 but to the memory regions 210 and 220, and the memory modules to be driven are selected by the selection signal CS. Consequently, the storage capacity of the storage unit 3250 to be used for the sub scanning shift can be reduced, and the power consumption and the calorific value of the memory can be reduced.

The inclination correction processing unit 32 (sub scanning shift processing unit 324) can be easily mounted in the ASIC, and the package of the ASIC can be made to be smaller. Furthermore, the number of the terminals of the ASIC can be also decreased. Moreover, by reducing the calorific value of the memory, the heat radiation measures of a substrate and a housing can be unnecessary.

By obtaining image data from an original with the scanner 10, the shift processing and the interpolation processing in the main scanning direction and the sub scanning direction can be performed with the image processing unit 30.

Because a plurality of regions of the storage unit 3250 in the main scanning direction is driven one by one in order according to the selection signal CS, the power consumption and the calorific value of the memory can be easily reduced.

Moreover, the addresses of the storage unit 3250 can be easily specified with the sub scanning shift control unit 3241, the counters 3242-3247, and the selector 3248, and the circulation quantities (counted values) according to the sub scanning shift quantities can be easily produced with the counters 3242-3247.

Because the image data in the regions where no sub scanning shift quantities of the main scanning line of the image data 200 exist is stored and is output as it is as the data signal DO by means of the comparator 3249 and the selector 3251, the storage capacity of the memory to be used for the sub scanning shift can be more reduced.

The descriptions concerning the above embodiment are related to one example of a suitable image processing apparatus according to the present invention, and the image processing apparatus of the present invention are not limited to the above one.

For example, although a description has been given to the case where the upper limit counted value of the memory modules in the storage unit 3250 in the sub scanning shift processing in the above embodiment is 6, the upper limit counted value is not limited to 6, but may be set 5 or less or 7 or more. If the upper limit counted value of the memory modules is increased, the sub scanning shift processing can be performed to the image data having a large upper limit inclination angle δ. If the upper limit counted value of the memory modules is decreased, the storage capacity of the storage unit 3250 can be further reduced.

Although the digital copier 1 including the scanner 10 as an image reading apparatus has been described in the above embodiment, the image reading apparatus is not limited to the scanner 10. The image reading apparatus may be a scanner apparatus as the image reading apparatus, a facsimile machine including the image reading apparatus, a multi function printer (MFP), or the like. Moreover, the image reading apparatus may be an image processing apparatus having only the function of performing image processing including the sub scanning shift processing to the image data read by an image reading apparatus as a separated body. Furthermore, the present invention can be used for the correction of a setting inclination to the sub scanning direction of a printer head in a printer apparatus including a solid state scanning type printer head such as a light emitting diode (LED) array and a PLZT optical shutter array.

The detailed configuration and the detailed operation of each unit constituting the digital copier 1 of the above embodiment may be suitably changed within the range of not departing from the scope of the present invention.

The present U.S. patent application claims a priority under the Paris Convention of Japanese patent application No. 2006-196995 filed on Jul. 19, 2006, and is entitled to the benefit thereof for a basis of correction of an incorrect translation.

What is claimed is:

1. An image processing apparatus comprising:
a storage unit including a plurality of memory modules, the storage unit storing image data having been subjected to main scan shifting into the memory modules, wherein the storage unit is configured so that a memory module taking charge of a larger shifting amount at a time of sub scan shifting of the image data has a larger summation storage capacity; and
a control unit selecting memory modules necessary for reading and writing the storage unit according to an inclination of the image data, and performing the reading and the writing of the image data into the selected memory modules.

2. The image processing apparatus according to claim 1, wherein
the memory modules are separately arranged in a plurality of regions with regard to a main scanning direction, and one of the plurality of regions is selected to be driven; and
the control unit sequentially selects one of the plurality of regions in the main scanning direction to perform the reading and the writing of the image data.

3. The image processing apparatus according to claim 1, wherein the control unit circularly selects the memory modules to which the reading and the writing of the image data are performed according to the shifting amount of the sub scan shifting.

4. The image processing apparatus according to claim 3, wherein the control unit includes:
a sub scan shifting control unit outputting an address in one direction for the reading and the writing of the storage unit;
a counter unit counting a counted value indicating a circulation amount according to the shifting amount of the sub scan shifting; and
a first selector selecting the counted value to output the selected counted value as an address in another direction for the reading and the writing of the storage unit.

5. The image processing apparatus according to claim 4, wherein the counter unit is arranged according to a position of the main scanning direction, and the counter unit includes a plurality of counters outputting counted values according to the shifting amount of the sub scan shifting according to the position of the main scanning direction.

6. The image processing apparatus according to claim 1, further comprising a second selector switching image data input after being subjected to the main scan shifting processing and image data read from the storage unit to output the switched image data.

7. An image reading apparatus comprising:
a scanner reading an image of an original to output image data;
a main scan shifting processing unit performing main scan shifting to the read image data;
a storage unit including a plurality of memory modules, the storage unit storing the image data having been subjected to the main scan shifting, wherein the storage unit is configured so that a memory module taking charge of a larger shifting amount at a time of sub scan shifting of the image data has a larger summation storage capacity; and
a control unit selecting memory modules necessary for reading and writing the storage unit according to an inclination of the image data, and performing the reading and the writing of the image data into the selected memory modules.
